(19) United States
(12) Patent Application Publication
(10) Pub. No.: US 2025/0190163 A1
(43) Pub. Date: Jun. 12, 2025

(54) INPUT DEVICE SCREEN-SHARE FACILITATION

(71) Applicant: Microsoft Technology Licensing, LLC, Redmond, WA (US)

(72) Inventor: Roei Avraham HALOKHEM, Herzliya (IL)

(73) Assignee: Microsoft Technology Licensing, LLC, Redmond, WA (US)

(21) Appl. No.: 18/847,418

(22) PCT Filed: Mar. 16, 2023
(86) PCT No.: PCT/US2023/064523

§ 371 Date: Sep. 16, 2024

(30) Foreign Application Priority Data
Apr. 5, 2022 (NL) 2031499

(51) Int. Cl. G06F 3/14; G06F 3/02; G06F 3/0354

(52) U.S. Cl. CPC G06F 3/1454; G06F 3/02; G06F 3/03545

(57) ABSTRACT

A method for screen-share facilitation at an input device includes receiving, from a screen-share destination device, an identifier corresponding to the screen-share destination device. The input device detects a screen-share initiating user input to initiate screen sharing between the screen-share destination device and a screen-share source device, and transmits a screen-share initialization request to the screen-share destination device. The identifier of the screen-share destination device is transmitted to the screen-share source device to facilitate establishment of a screen-share pairing between the screen-share source device and the screen-share destination device. The screen-share pairing enables graphical content rendered by the screen-share source device to be displayed by the screen-share destination device.

### BACKGROUND

A computing device may render graphical content for presentation by an electronic display communicatively coupled to the computing device—e.g., a display integrated into a same housing as the computing device or connected to the computing device via a cable. In some cases, the computing device may additionally output graphical content for presentation by another display for purposes of “screen sharing”—e.g., allowing one or more observers to see the graphical content on a shared display, such as in a meeting or presentation context.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for screen-share facilitation at an input device includes receiving, from a screen-share destination device, an identifier corresponding to the screen-share destination device. The input device detects a screen-share initiating user input to initiate screen sharing between the screen-share destination device and a screen-share source device, and transmits a screen-share initialization request to the screen-share destination device. The identifier of the screen-share destination device is transmitted to the screen-share source device to facilitate establishment of a screen-share pairing between the screen-share source device and the screen-share destination device. The screen-share pairing enables graphical content rendered by the screen-share source device to be displayed by the screen-share destination device.

### BRIEF DESCRIPTION OF THE DRAWINGS

FIG. 1 schematically illustrates screen-sharing of graphical content.

FIG. 2 illustrates an example method for screen-share facilitation at an input device.

FIG. 3 schematically depicts exchange of data between an input device, a screen-share source device, and a screen-share destination device.

FIGS. 4A and 4B schematically illustrate an input device facilitating screen-share pairing.

FIG. 5 schematically illustrates electrostatic exchange of data between an input device and a screen-share source device.

FIG. 6 illustrates an example method for screen-sharing at a screen-share source device.

FIG. 7 illustrates an example method for screen-sharing at a screen-share destination device.

FIG. 8 schematically shows an example computing system.

### DETAILED DESCRIPTION

Graphical content rendered by a computing device may be transmitted to and displayed by a separate electronic display device in a “screen sharing” scenario. For example, during a meeting, a meeting participant may share graphical content rendered by their personal device (e.g., tablet, laptop, smartphone) to a larger nearby display—e.g., a shared television or touch display located in the conference room—to enable other participants in the meeting to see the participant's graphical content more clearly. However, establishing such a screen-share pairing can in some cases be tedious and time-consuming for the user, requiring navigation through potentially multiple menus on the screen-share source device in order to identify and select the appropriate screen-share destination device.

Accordingly, the present disclosure is directed to techniques for facilitating screen sharing between a screen-share source device and a screen-share destination device via an intermediary input device, such as a stylus. According to the techniques described herein, the input device receives an identifier corresponding to a screen-share destination device, such as a conference room display. Upon detecting an input to initiate screen sharing (e.g., based on actuation of a physical button on the stylus), the input device transmits the identifier of the screen-share destination device to a screen-share source device—e.g., a tablet device rendering graphical content that a user of the input device would like to share on the screen-share destination device. From there, the screen-share source device and screen-share destination device may initiate a screen-share pairing, in which graphical content rendered by the screen-share source device is presented by the screen-share destination device.

The techniques described herein may beneficially reduce the burden of user input to a computing device by simplifying the process of initiating screen sharing between the computing device and a separate display. In one example, screen-sharing may be initiated when a user presses a physical button on a stylus currently paired with a screen-share destination device, then brings the stylus into relatively close proximity (e.g., within a few millimeters) of a display integrated into a screen-share source device. This is potentially faster and simpler than requiring the user to navigate through one or more interface menus to identify and select their desired destination device. Furthermore, the techniques described herein may provide a technical benefit of improving human-computer interaction by reducing the likelihood that a user may inadvertently share graphical content to and/or from an unintended device. For example, the screen-share destination device may be paired with the input device (e.g., via a suitable radio-frequency communication protocol such as Bluetooth®), and screen sharing may be initiated when the user moves the input device toward their intended screen-share source device (e.g., their personal tablet), thereby reducing the risk that content will be shared from an unintended device.

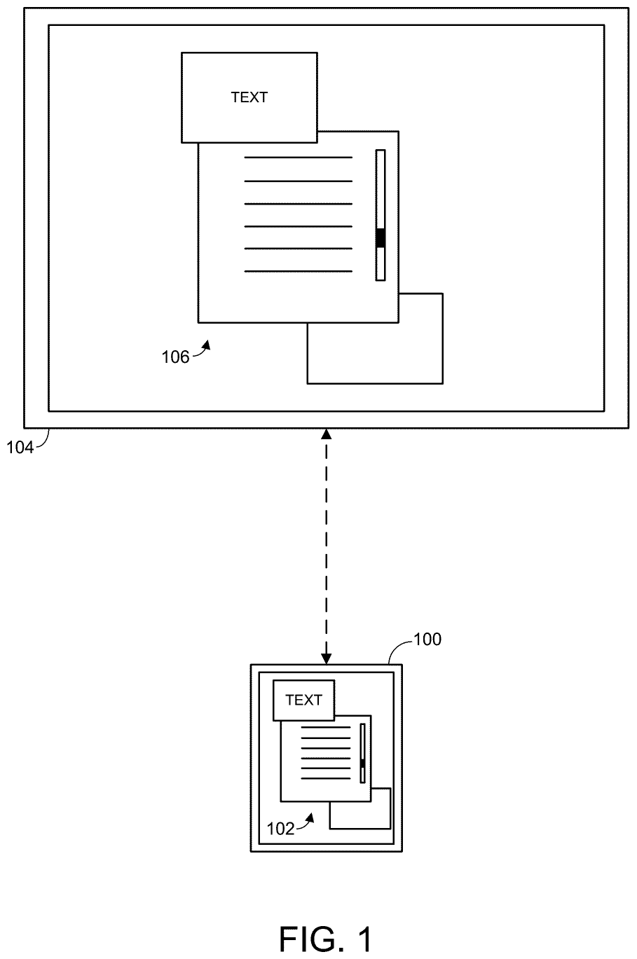

FIG. 1 schematically illustrates an example screen-sharing scenario. Specifically, in FIG. 1, a screen-share source device 100 is rendering local graphical content 102 for display on an electronic display integrated into the screen-share source device. Furthermore, the screen-share source device has established a screen-share pairing with a screen-share destination device 104, currently presenting screen-share graphical content 106.

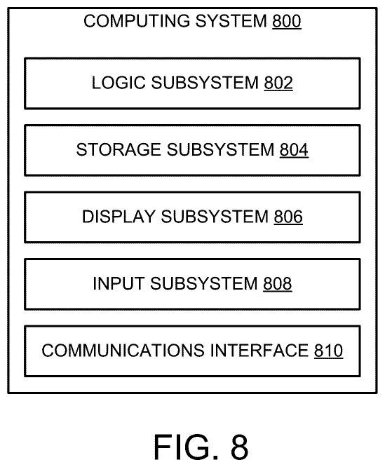

It will be understood that the specific devices and graphical content shown in FIG. 1 is non-limiting and used only for the sake of example. Specifically, screen-share source device 100 in this case takes the form of a mobile device with an integrated display, such as a smartphone or tablet. Furthermore, the screen-share destination device 104 takes the form of a relatively larger device including a larger electronic display—e.g., such as a television, monitor, or large form-factor touch screen device. However, in general, the screen-share source device and screen-share destination device as used herein may each have any suitable capabilities, hardware configuration, and form factor. For example, the screens-share destination device need not include a larger display than the screen-share source device, but rather in some cases may include a display that is smaller or substantially the same size. In some examples, either or both of the screen-share source device and screen-share destination device may be implemented as computing system 800 described below with respect to FIG. 8.

In general, the screen-share source device may take the form of any computing system of one or more computing devices suitable for rendering graphical content for display, including local graphical content and screen-share graphical content. As used herein, “local graphical content” generally refers to any graphical content rendered by a screen-share source device for presentation on one or more “primary” displays associated with the screen-share source device—e.g., displays that present any graphical content output by the screen-share source device regardless of whether screen sharing is active. In some cases, the local graphical content may be presented by a primary display integrated into a same housing as the screen-share source device, such as is the case in FIG. 1. Additionally, or alternatively, the screen-share source device may present local graphical content via an external display communicatively coupled to the screen-share source device—e.g., via a suitable cable or wireless connection. Thus, the screen-share source device may take the form of a smartphone, tablet, laptop, desktop, and/or any other suitable type of computing system.

Similarly, the screen-share destination device may take the form of any electronic device suitable for presenting screen-share graphical content output by a screen-share source device. Notably, the screen-share destination device will typically only present graphical content from any particular screen-share source device when a suitable screen-share pairing has been established between the source and destination devices. Thus, the screen-share destination device may present graphical content originating from different screen-share source devices at different times, and may in some cases be configured to present screen-share graphical content from two or more screen-share source devices at once.

The screen-share destination device may in some cases present the screen-share graphical content on an electronic display integrated into the same housing as the screen-share destination device. For example, the screen-share destination device may take the form of a television, monitor, meeting collaboration device (e.g., a relatively large touch-screen display mounted to a wall or used as a table surface), or any other suitable form factor including an integrated display. However, it will be understood that this need not always be the case. As another example, the screen-share destination device may include image presentation componentry other than an electronic display—e.g., the screen-share destination device may take the form of a projector configured to form a display image by emitting light onto another surface, such as a wall or projector screen. As another example, the screen-share destination device need not include onboard image forming componentry, but rather may be communicatively coupled with another electronic device that does. For instance, the screen-share destination device may take the form of a dongle, media center device, or other suitable computing device communicatively coupled with an electronic display or projector.

In the example of FIG. 1, the local graphical content presented by the screen-share source device has a substantially similar appearance to the screen-share graphical content presented by the screen-share destination device, with the exception that the screen-share graphical content has a relatively larger size proportional to the larger display size of the screen-share destination device. In other words, the screen-share graphical content output for display by the screen-share destination device duplicates the local graphical content. In general, the size of the screen-share graphical content may beneficially be scaled up or down depending on the display size of the screen-share destination device. Alternatively, in some cases, the local graphical content and screen-share graphical content may have substantially the same size, even if displays used by the screen-share source device and screen-share destination device have different sizes.

Furthermore, the screen-share graphical content need not always duplicate or otherwise resemble the local graphical content. In other words, the screen-share graphical content may be different from the local graphical content. In one example scenario, the screen-share graphical content may take the form of a slideshow presentation, while the local graphical content includes a user's personal notes that are not output for display by the screen-share destination device. This may be done, for example, when the screen-share destination device is classified as an extended display of the screen-share source device—e.g., an operating system of the screen-share source device may allow different content to be displayed on the primary and extended displays. In other cases, a user of the screen-share source device may manually select one or more application windows, interface elements, and/or other graphical content elements for presentation by either or both of the screen-share source device and destination device. In general, a user of the screen-share source device may beneficially customize the appearance of the screen-share graphical content in any suitable way—e.g., in some scenarios, it may be desirable for the screen-share graphical content to duplicate the local graphical content, and in other scenarios it may be desirable for the screen-share graphical content to differ from the local graphical content.

Furthermore, it will be understood that the specific graphical content shown in FIG. 1 is non-limiting and included only for the sake of example. As used herein, “graphical content” can include any suitable visual content rendered for display by a suitable display device, and can include images, videos, application windows, user interface elements, etc.

As used herein, a “screen-share pairing” between a screen-share source device and a screen-share destination device will typically be a wireless connection that enables the screen-share destination device to display screen-share graphical content output by the screen-share source device. Such data may be transmitted in any suitable way. For example, both the screen-share source device and screen-share destination device may each connect to the same wireless computer network—e.g., instantiated by a local internet router, or the network may be an ad-hoc network established by the screen-share destination device. As another example, the screen-share source device and destination device may connect via a suitable RF data communication protocol, such as Bluetooth®. In general, the screen-share source device and destination device may communicate in any suitable manner, and the data transmitted between the different devices may take any suitable form and use any suitable formatting and encoding.

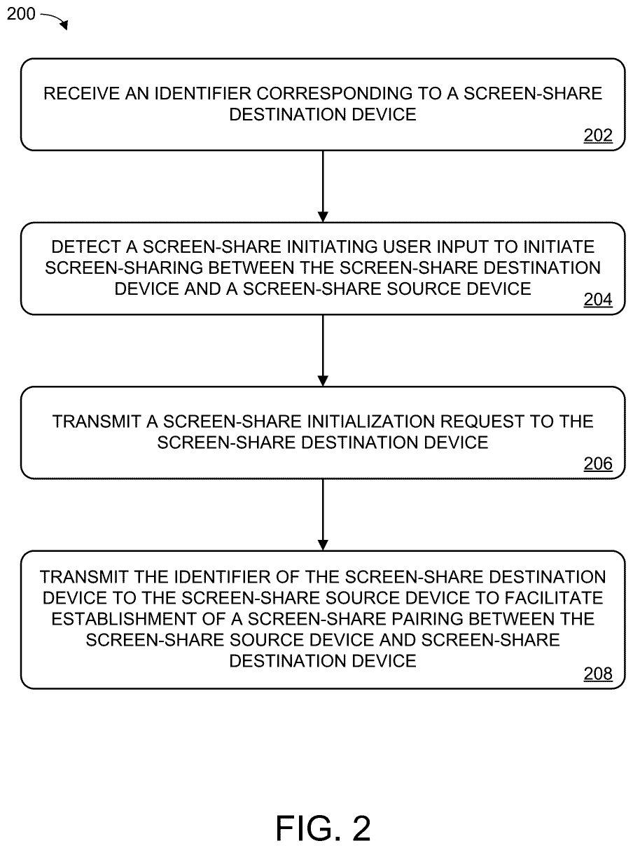

As discussed above, establishment of a screen-share pairing between a screen-share source device and destination device may beneficially be facilitated by an intermediary input device. Accordingly, FIG. 2 illustrates an example method 200 for screen-share facilitation. Method 200 is generally described as being implemented by an input device, such as an active stylus. In general, method 200 may beneficially be implemented by any suitable input device configured to exchange data with both the screen-share source device and screen-share destination device. As other non-limiting examples, the input device may take the form of a computer mouse, keyboard, wireless microphone and/or headphones, etc. However, it will be understood that any or all steps of method 200 may generally be implemented by any suitable electronic system of one or more different electronic devices. Any electronic device performing steps of method 200 may have any suitable capabilities, hardware configuration, and form factor. In some examples, method 200 may be implemented by computing system 800 described below with respect to FIG. 8.

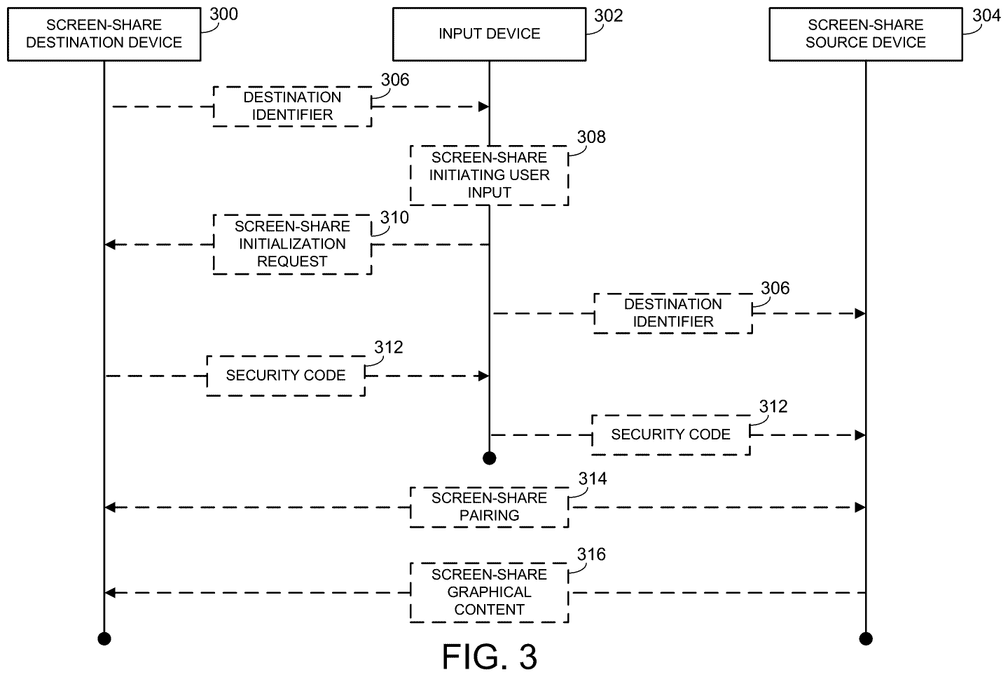

At 202, method 200 includes receiving, from a screen-share destination device, an identifier corresponding to the screen-share destination device. This is illustrated with respect to FIG. 3, schematically illustrating exchange of different types of data between a screen-share destination device 300, an input device 302, and a screen-share source device 304. The screen-share source and destination devices may be implemented as described above with respect to FIG. 1—e.g., the screen-share source device may take the form of any device suitable for rendering graphical content, while the screen-share destination device may be any suitable device configured to receive and present at least some of the rendered graphical content. The present disclosure primarily focuses on an input device taking the form of an active stylus, although as discussed above, this is non-limiting, and other input devices may additionally or alternatively be used.

In FIG. 3, the input device 302 receives an identifier 306 corresponding to the screen-share destination device. The identifier may take any suitable form. As one non-limiting example, the identifier corresponding to the screen-share destination device may be a media access control (MAC) address of the screen-share destination device. In general, however, the identifier may be any suitable data useable by the screen-share source device to identify the destination device for the purposes of establishing a screen-share pairing—e.g., the identifier may be useable to distinguish the screen-share destination device from other potential destination devices on a same computer network. As such, the identifier corresponding to the screen-share destination device may take a variety of suitable forms depending on the specific implementation.

The identifier may be transmitted to the input device in any suitable manner. In some cases, the input device and screen-share destination device may already be electronically paired—e.g., via a suitable RF communication protocol such as Bluetooth®. Thus, the input device may receive the identifier corresponding to the screen-share destination at the time such an electronic pairing is established, and before an input to initiate screen sharing is received. In other examples, however, the identifier corresponding to the screen-share destination device may be received by the input device at another suitable time, such as after the input device has received an input to initiate screen sharing.

As another example, the identifier corresponding to the screen-share destination device may be transmitted electrostatically. As will be described in more detail below, an electronic display may include a plurality of display electrodes, and the input device may include one or more input device electrodes that are sensitive to local electrical conditions. For example, an active stylus may include one or more stylus electrodes, and either or both of the screen-share source and screen-share destination devices may include electronic displays having respective sets of display electrodes. By driving electrodes with an encoded electrostatic drive signal, local electrical conditions may be influenced in a manner that is detectable by another nearby device. Thus, for instance, display electrodes of the screen-share destination device may be driven with an encoded electrostatic signal detectable by the input device (e.g., a stylus contacting or hovering in close proximity to the display surface). By decoding the detected electrical conditions caused by application of the drive signal, the input device may receive the identifier corresponding to the screen-share destination device.

Returning briefly to FIG. 2, at 204, method 200 includes detecting a screen-share initiating user input to initiate screen sharing between the screen-share destination device and the screen-share source device. In FIG. 3, this is indicated by screen-share initiating user input 308 received at input device 302. The screen-share initiating user input may take any suitable form, depending on the specific characteristics of the input device.

As one non-limiting example, detecting the screen-share initiating user input may include detecting actuation of a physical button of the input device. In other words, the input device may have one or more different physical buttons, configured to activate one or more different functions of the input device when actuated. Furthermore, in some cases, the same physical button of the input device may be used to activate multiple different functions, depending on the specific manner in which the physical button is actuated. In other words, a logic controller of the input device may be configured to recognize two or more different predefined input types each associated with different actuation profiles of the physical button, where the two or more different predefined input types include the screen-share initiating user input.

An actuation profile associated with the screen-share initiating user input may, for instance, specify one or both of an actuation duration of the physical button (e.g., button must be pressed for at least one second), and a number of separate actuations of the physical button within a threshold time interval (e.g., button pressed three times within a 3 three second interval). Other actuation profiles associated with other actuation durations and/or separate actuations within a time interval may be associated with other predefined input types supported by the input device. For example, other predefined input types may include an input to launch a software application on a paired computing device, enable/disable functionality of the input device (e.g., a haptic feedback function, a network connectivity function), change an audio volume of a paired computing device, etc. This may beneficially reduce the burden of user input to the device by enabling control of several different functions via one input mechanism, which is potentially less confusing to the user than inclusion of multiple different mechanisms.

However, it will be understood that the screen-share initiating user input may be detected in other ways in addition to, or instead of, actuation of a physical button. The input device may include any suitable number and variety of physical mechanisms that, when manipulated, cause activation of different functions—e.g., buttons, switches, sliders, touch sensors, or motion sensors. Depending on the specific configuration of the input device, any suitable detectable manipulation of the input device may be interpreted as a screen-share initiating user input—e.g., movement of a switch, contact at a touch-sensitive region, or a detected real-world movement consistent with a predetermined gesture.

Returning briefly to FIG. 2, at 206, method 200 includes transmitting a screen-share initialization request to the screen-share destination device. In FIG. 3, input device 302 transmits a screen-share initialization request 310 to screen-share destination device 300. The screen-share initialization request may take any suitable form. In general, the screen-share initialization request may be useable to activate a screen-sharing functionality (e.g., software application) of the screen-share destination device. In other words, the screen-share initialization request prompts the screen-share destination device to expect an incoming screen-share pairing from the screen-share destination device. It will be understood that this may be done in various suitable ways depending on the specific configuration of the input device and screen-share destination device.

Furthermore, the screen-share initialization request may be transmitted in any suitable way. In some cases, the screen-share initialization request may be transmitted via a same communication modality as the identifier corresponding to the screen-share destination device. For example, the input device may transmit the screen-share initialization request via an RF communication protocol such as Bluetooth®, and/or electrostatically via application of an encoded drive signal to one or more suitable electrodes of the input device. In other cases, the identifier of the screen-share destination device and the screen-share initialization request may be exchanged via different communication modalities.

Returning briefly to FIG. 2, at 208, method 200 includes transmitting the identifier of the screen-share destination device to the screen-share source device. This facilitates establishment of a screen-share pairing between the screen-share source device and the screen-share destination device, where the screen-share pairing enables graphical content rendered by the screen-share source device to be displayed by the screen-share destination device. In FIG. 3, input device 302 transmits the identifier 306 corresponding to the screen-share destination device to the screen-share source device.

The identifier of the screen-share destination device may be transmitted to the screen-share source device in any suitable way. Notably, the identifier of the screen-share destination device may be transmitted to the screen-share source device via a different communication modality from how it was earlier received from the screen-share destination device. In other words, the identifier may be received from the screen-share destination device via a first communication modality, and transmitted to the screen-share source device via a second communication modality, different from the first communication modality.

As one example, the first communication modality may be an RF communication modality as discussed above, such as Bluetooth®. The second communication modality may be an electrostatic communication modality, in which one or more electrodes of the input device are driven with an encoded drive signal that influences electrical conditions at one or more electrodes of the screen-share source device. This may, for instance, enable the input device to receive the identifier from the screen-share destination device over a relatively large distance (e.g., on the order of several meters), then transmit the identifier to the screen-share source device when it is brought into relatively close proximity with the source device (e.g., when a stylus is touching or hovering over the surface of an integrated display of the source device). In this manner, a user may “select” the source device that they would like to begin transmitting graphical content to the screen-share destination device by physically moving the input device close to their selected source device.

It will be understood, however, that this scenario is non-limiting. As another example, the first communication modality may be electrostatic while the second communication modality uses a suitable RF communication protocol. In some cases, the input device may use the same communication modality for communication with both the screen-share source device and screen-share destination device—e.g., both may be electrostatic or both may use a suitable RF protocol. Furthermore, it will be understood that the specific communication modalities described herein are non-limiting examples—in general, two electronic devices may exchange data in a wide variety of suitable ways, any of which may be used according to the techniques described herein.

Upon receiving the identifier corresponding to the screen-share destination device, the screen-share source device may initiate a screen-share pairing with the screen-share destination device. In FIG. 3, screen-share source device 304 and screen-share destination device 300 establish a screen-share pairing 314, in which the two devices communicate directly—e.g., the input device is no longer used as an intermediary.

As discussed above, the identifier may take the form of any computer data useable by the screen-share source device to identify the screen-share destination device and distinguish it from other potential destination devices that may be present. Thus, upon receiving the identifier, the screen-share source device may transmit a suitable connection request to the screen-share destination device referenced by the identifier. Depending on the specific software configurations of the screen-share source and destination devices, the two devices may exchange any suitable data (e.g., requests, acknowledgements, verifications) in the process of establishing a screen-share pairing. Notably, as discussed above, this data may be exchanged directly between the screen-share source device and screen-share destination device—e.g., the input device is no longer used as an intermediary for relaying data between the two devices.

However, in some cases, additional security verification may be performed prior to the screen-share pairing being established. For example, the input device may optionally receive a security code from the screen-share destination device, then transmit the security code to the screen-share source device. In FIG. 3, input device 302 receives a security code 312 from screen-share destination device 300, then transmits the security code to screen-share source device 304.

The security code may take any suitable form. In general, the security code may take the form of any suitable data that can be used by the screen-share destination device to validate that it is about to begin presenting screen-share graphical content output by the correct screen-share source device. For example, as discussed above, the security code generated by the screen-share destination device may be relayed to the screen-share source device by the input device. In the process of establishing the screen-share pairing, the screen-share source device may directly transmit the security code back to the screen-share destination device. If the security code received by the screen-share destination device matches the one it previously transmitted to the input device, the screen-share destination device may accept the screen-share pairing and begin displaying graphical content. However, if the security code does not match, this may be an indication that the screen-share destination device is communicating with an unintended source device. Thus, the screen-share destination device may reject the screen-share pairing, to avoid a scenario where the screen-share destination device begins presenting unintended graphical content. This may beneficially provide a way to control access to the screen-share destination device—e.g., to prevent unauthorized parties from presenting unauthorized graphical content.

In any case, upon establishing a screen-share pairing, the screen-share destination device may begin presenting screen-share graphical content output by the screen-share source device. In FIG. 3, screen-share source device 304 outputs screen-share graphical content 316 for presentation by the screen-share destination device. As discussed above, the screen-share graphical content may be transmitted in any suitable way, and may take any suitable form, depending on the specific configurations of the screen-share source and destination devices, and the network environment over which the two devices communicate.

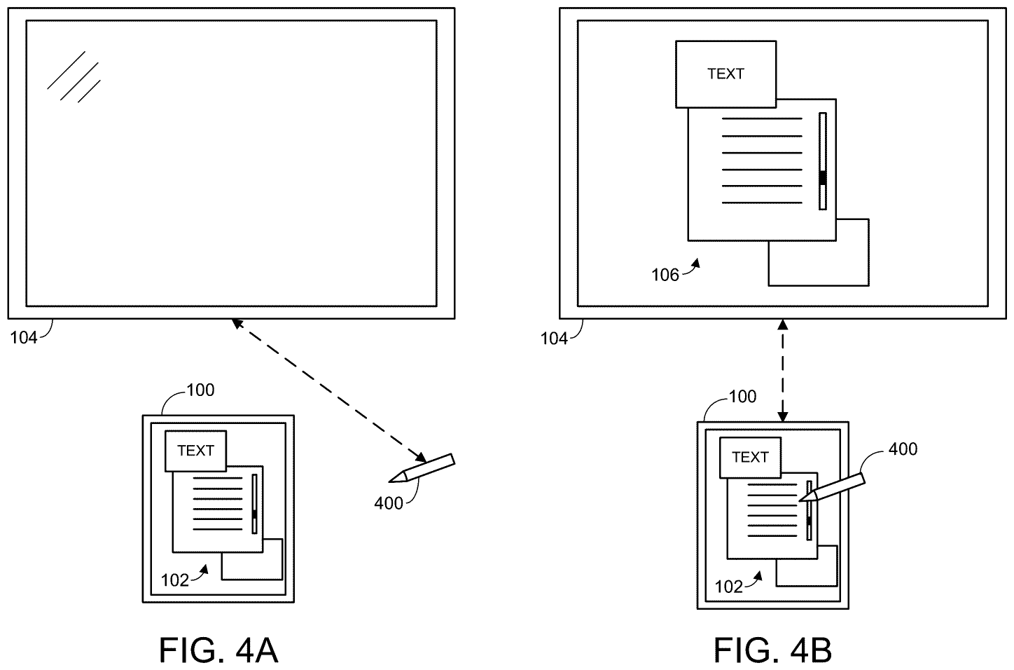

The process of establishing a screen-share pairing is further illustrated with respect to FIGS. 4A and 4B. Specifically, FIG. 4A again schematically shows screen-share source device 100 and screen-share destination device 104 of FIG. 1. In FIG. 4A, the screen-share source device is presenting local graphical content 102, although the screen-share destination device is not currently presenting any graphical content, as there is not yet a screen-share pairing between the screen-share source and destination devices.

However, the screen-share destination device is communicating with an example input device 400, taking the form of an active stylus. For example, the input device may be paired with the screen-share destination device via a suitable RF communication protocol (e.g., Bluetooth®), enabling the input device to control functionality of the screen-share destination device. As such, the screen-share destination device may transmit an identifier to the input device—e.g., as part of establishing the RF data pairing, and/or for purposes of facilitating an eventual screen-share pairing. Furthermore, upon detecting a screen-share initiating user input, the input device may transmit a screen-share initialization request to the screen-share destination device, as discussed above.

In FIG. 4B, the input device has been brought into relatively close proximity with a display surface of an integrated display of screen-share source device 100. For example, as discussed above, the identifier of the screen-share destination device may be transmitted to the screen-share source device electrostatically. Thus, when a stylus is brought close to a display surface (e.g., within a range of a few millimeters), one or more stylus electrodes of the stylus may be driven with an encoded drive signal detectable at one or more display electrodes of the screen-share source device. By decoding the detected signal, the screen-share source device may receive the identifier of the screen-share destination device, and initiate the screen-share pairing.

This is shown in FIG. 4B, in which a screen-share pairing has been established between screen-share source device 100 and screen-share destination device 104. Thus, the screen-share destination device is presenting screen-share graphical content 106 output by the screen-share source device.

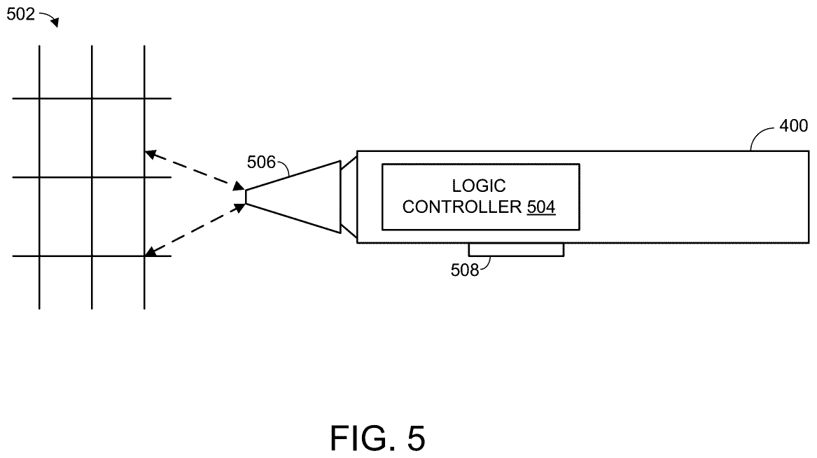

As discussed above, the techniques described herein may in some cases be facilitated via electrostatic data communication between an input device (e.g., a stylus) and either or both of the screen-share source and destination devices. This is schematically illustrated with respect to FIG. 5. Specifically, FIG. 5 again shows input device 400 of FIG. 4, electrostatically communicating with a plurality of display electrodes 502. In FIG. 5, the display electrodes are represented by a grid of intersecting lines, although it will be understood that this is done only for the sake of illustration. In practical cases, the display electrodes may have any suitable appearance, and may in some cases be occluded by the display surface. Furthermore, as discussed above, either or both of the screen-share source and destination devices may electrostatically communicate with the input device. Thus, display electrodes 502 may generally represent display electrodes associated with either the source or destination device.

In FIG. 5, the input device includes a logic controller 504. The logic controller may take the form of any suitable computer processing hardware configured to perform any or all of the computing techniques described herein. For example, logic controller 504 may perform any or all steps of method 200. As non-limiting examples, the logic controller may take the form of a computer processor, system-on-a-chip (SoC), or application-specific integrated circuit (ASIC). In some cases, the logic controller may be implemented as a logic machine described below with respect to FIG. 8.

For the purposes of FIG. 5, the logic controller may perform functions relating to electrostatic communication between the input device and display electrodes 502. As shown, input device 400 includes an electrode 506, disposed in the stylus tip. As discussed above, display electrodes 502 may be driven with an encoded drive signal to influence electrical conditions in their local vicinity. This change in electrical conditions may be detectable by electrode 506 of the input device. By interpreting and decoding the detected signal, the logic controller may receive data transmitted by a device associated with the display electrodes. Similarly, the electrode of the input device may be driven with an encoded drive signal that is detectable by the plurality of display electrodes. In this manner, unidirectional or bidirectional communication between the input device and one or more other devices (e.g., the screen-share source and/or destination devices) may be established.

It will be understood, however, that the techniques described herein need not be limited to electrostatic communication, and may not even include electrostatic communication. Rather, as discussed above, an input device and separate computing device may communicate over a wide variety of different suitable communication modalities, of which electrostatic communication is only one non-limiting example.

Furthermore, in FIG. 5, the input device includes a physical button 508. As discussed above, actuation of the physical button may in some cases be detected as a screen-share initiating user input. Thus, in response to detecting actuation of the physical button, the logic controller may in some cases transmit a screen-share initialization request to the screen-share destination device, as discussed above. It will be understood, however, that a physical button is only one non-limiting example of a suitable mechanism useable to provide a screen-share initiating user input to an input device. Furthermore, in some cases, the same mechanism (e.g., physical button) may be configured to activate two or more different functions of the input device. As such, the screen-share initiating user input may only be detected if the manipulation of the mechanism meets certain criteria—e.g., if actuation of a physical button meets a predefined actuation profile as discussed above.

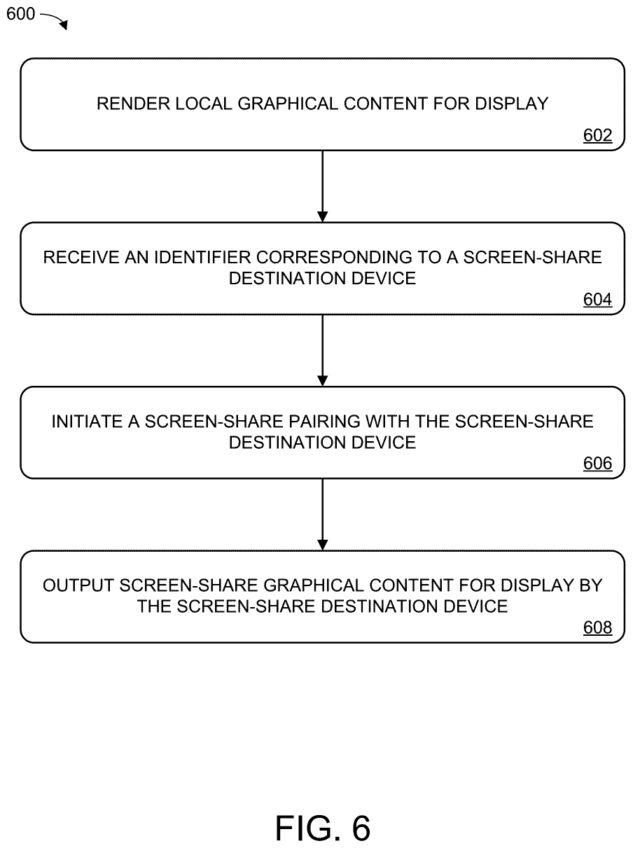

The present disclosure has thus far primarily focused on actions performed by the input device in establishing a screen-share pairing between screen-share source and destination devices. FIG. 6 illustrates another example method 600, including steps performed by a screen-share source device. As with method 200, method 600 may be performed by any suitable computing system of one or more computing devices. Any computing device performing steps of method 600 may have any suitable capabilities, hardware configuration, and form factor. In some cases, method 600 may be implemented by computing system 800 described below with respect to FIG. 8.

At 602, method 600 includes rendering local graphical content for display via an electronic display device communicatively coupled with the computing device. As discussed above, the electronic display device used to present the local graphical content may have any suitable relationship with respect to the computing device rendering the graphical content. For example, the screen-share source device may include an integrated display (e.g., such as screen-share source device 100). Additionally, or alternatively, the local graphical content may be presented on an electronic display device external to the computing device—e.g., connected to the computing device via a suitable wired or wireless connection.

Furthermore, as discussed above, the graphical content may take any suitable form. As non-limiting examples, the graphical content may include images, videos, text, user interface elements, and/or any other suitable visual content rendered by a computing device.

At 604, the method includes receiving, from an input device separate from the computing device, an identifier corresponding to a screen-share destination device. Notably, as discussed above, the identifier originates from the screen-share destination device and is related by the separate input device. For example, in FIG. 3, screen-share source device 304 receives the identifier 306 corresponding to screen-share destination device 300 via input device 302.

As discussed above, the input device and identifier may each take any suitable form, and the identifier may be transmitted in any suitable way. For example, the identifier corresponding to the screen-share destination device may be a MAC address of the screen-share destination device, or may take the form of other data suitable for use by the screen-share source device to distinguish between the screen-share destination device and other potential devices in the same network environment. The input device may in some cases take the form of an active stylus, or any other suitable input device. Furthermore, the identifier corresponding to the screen-share destination device may be received by decoding a change in electrical conditions detected at one or more display electrodes of the electronic display device, where the change in electrical conditions is caused by an electrostatic drive signal applied to one or more electrodes (e.g., stylus electrodes) of the input device. In other examples, however, other suitable communication modalities may be used to transmit the identifier from the input device to the screen-share source device.

Continuing with FIG. 6, at 606, method 600 includes initiating a screen-share pairing with the screen-share destination device. As discussed above, this may be done in any suitable way depending on the configurations of the screen-share source and destination devices—e.g., the two devices may exchange any suitable messages, requests, acknowledgements, verifications, and/or other types of data. As one example, the screen-share source device may receive, from the input device, a security code originating from the screen-share destination device. As such, initiating the screen-share pairing may include authenticating the security code with the screen-share destination device.

At 608, method 600 includes outputting screen-share graphical content for display by the screen-share destination device. As discussed above, the screen-share graphical content output for display by the screen-share destination device may in some cases duplicate the local graphical content displayed by the screen-share source device. In other words, the local graphical content may be substantially identical to the screen-share graphical content (although may in some cases have a different size based on the displayable area of the screen-share destination device). In other cases, however, the screen-share graphical content may be different from the local graphical content. For example, the screen-share destination device may be classified as an external display, allowing a user to present different graphical content from the local graphical content shown on the primary display of the screen-share source device.

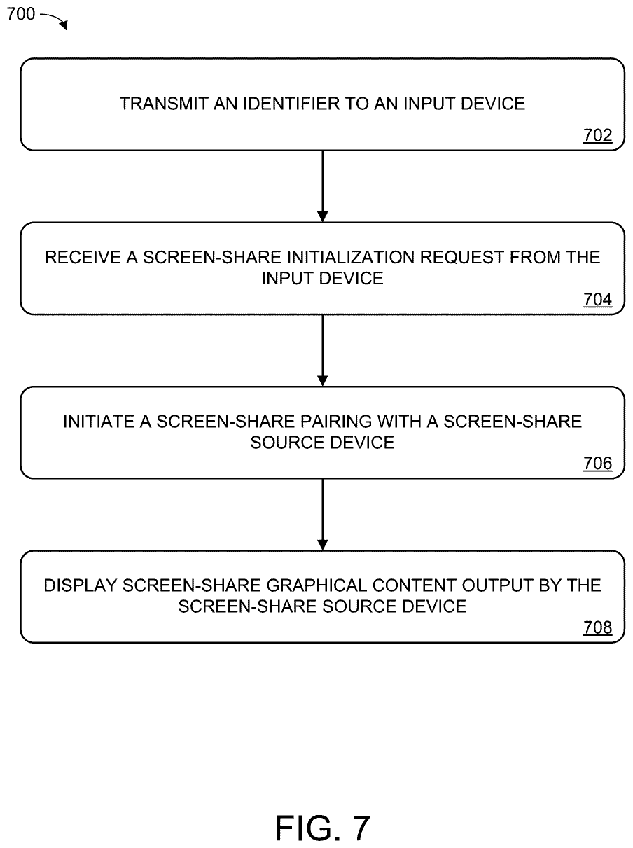

FIG. 7 illustrates another example method 700, including steps performed by a screen-share destination device. As with methods 200 and 600, method 700 may be performed by any suitable computing system of one or more computing devices. Any computing device performing steps of method 700 may have any suitable capabilities, hardware configuration, and form factor. In some cases, method 700 may be implemented by computing system 800 described below with respect to FIG. 8.

At 702, method 700 includes transmitting an identifier corresponding to the computing device to an input device separate from the computing device. The identifier and input device may each take any suitable form, and the identifier may be transmitted in any suitable way. For example, the identifier corresponding to the computing device may be a MAC address of the computing device, or may take any other suitable form. Furthermore, the identifier may be transmitted to the input device via a suitable RF communication modality, and/or any other suitable communication modality may be used.

At 704, method 700 includes receiving a screen-share initialization request from the input device. This may be done substantially as described above with respect to FIG. 3. For example, the screen-share initialization request may activate screen sharing functionality of the screen-share destination device (e.g., a software application), and prepare the screen-share destination device to respond to an incoming screen-share pairing from a screen-share source device.

At 706, method 700 includes initiating a screen-share pairing with the screen-share source device, the screen-share source device having received the identifier corresponding to the screen-share destination device from the input device. As discussed above, in some cases this may occur after transmitting a security code to the input device. The screen-share pairing may be initiated after authenticating the security code with the screen-share source device.

At 708, method 700 includes displaying screen-share graphical content output by the screen-share source device via an electronic display. As discussed above, the electronic display may take any suitable form and may have any suitable relationship with respect to the screen-share destination device. For example, the electronic display may be an integrated display, image-forming componentry associated with a projector, or the display may be external to the screen-share destination device (e.g., the destination device may take the form of a dongle or media center device communicatively coupled with a suitable display).

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 8 schematically shows a simplified representation of a computing system 800 configured to provide any to all of the compute functionality described herein. Computing system 800 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 800 includes a logic subsystem 802 and a storage subsystem 804. Computing system 800 may optionally include a display subsystem 806, input subsystem 808, communication subsystem 810, and/or other subsystems not shown in FIG. 8.

Logic subsystem 802 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 804 includes one or more physical devices configured to temporarily and/or permanently hold computer information such as data and instructions executable by the logic subsystem. When the storage subsystem includes two or more devices, the devices may be collocated and/or remotely located. Storage subsystem 804 may include volatile, nonvolatile, dynamic, static, read/write, read-only, random-access, sequential-access, location-addressable, file-addressable, and/or content-addressable devices. Storage subsystem 804 may include removable and/or built-in devices. When the logic subsystem executes instructions, the state of storage subsystem 804 may be transformed—e.g., to hold different data.

Aspects of logic subsystem 802 and storage subsystem 804 may be integrated together into one or more hardware-logic components. Such hardware-logic components may include program-and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 806 may be used to present a visual representation of data held by storage subsystem 804. This visual representation may take the form of a graphical user interface (GUI). Display subsystem 806 may include one or more display devices utilizing virtually any type of technology. In some implementations, display subsystem may include one or more virtual-, augmented-, or mixed reality displays.

When included, input subsystem 808 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 810 may be configured to communicatively couple computing system 800 with one or more other computing devices. Communication subsystem 810 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method at an input device for facilitating screen-share between a screen-share source device and a screen-share destination device comprises the input device: receiving, from the screen-share destination device, an identifier corresponding to the screen-share destination device; detecting a screen-share initiating user input to initiate screen sharing between the screen-share destination device and the screen-share source device; transmitting a screen-share initialization request to the screen-share destination device; and transmitting the identifier of the screen-share destination device to the screen-share source device to facilitate establishment of a screen-share pairing between the screen-share source device and the screen-share destination device, wherein the screen-share pairing enables graphical content rendered by the screen-share source device to be displayed by the screen-share destination device. In this example or any other example, the identifier is received from the screen-share destination device via a first communication modality, and the identifier is transmitted to the screen-share source device via a second communication modality, different from the first communication modality. In this example or any other example, the first communication modality is a radio-frequency (RF) communication modality, and the second communication modality is an electrostatic communication modality, in which one or more electrodes of the input device are driven with an encoded drive signal that influences electrical conditions at one or more electrodes of the screen-share source device. In this example or any other example, the method further comprises receiving a security code from the screen-share destination device, and transmitting the security code to the screen-share source device. In this example or any other example, detecting the screen-share initiating user input includes detecting actuation of a physical button of the input device. In this example or any other example, a logic controller of the input device is configured to recognize two or more different predefined input types that are each associated with different actuation profiles of the physical button, the two or more different predefined input types including the screen-share initiating user input. In this example or any other example, an actuation profile associated with the screen-share initiating user input specifies one or both of an actuation duration of the physical button, and a number of separate actuations of the physical button within a threshold time interval. In this example or any other example, the identifier corresponding to the screen-share destination device is a media access control, MAC, address of the screen-share destination device. In this example or any other example, the input device is physically distinct from each of the screen-share source device and the screen-share destination device.

In an example, a computing device comprises: a logic subsystem; and a storage subsystem holding instructions executable by the logic subsystem to: render local graphical content for display via an electronic display device communicatively coupled with the computing device; receive, from an input device separate from the computing device, an identifier corresponding to a screen-share destination device, the identifier originating from the screen-share destination device and relayed by the separate input device, the screen-share destination device different from the electronic display device; initiate a screen-share pairing with the screen-share destination device based at least in part on the identifier; and output screen-share graphical content for display by the screen-share destination device. In this example or any other example, the screen-share graphical content output for display by the screen-share destination device duplicates the local graphical content. In this example or any other example, the screen-share destination device is classified as an extended display of the computing device, and the screen-share graphical content output for display by the screen-share destination device is different from the local graphical content. In this example or any other example, the instructions are further executable to receive, from the input device, a security code originating from the screen-share destination device, and initiating the screen-share pairing includes authenticating the security code with the screen-share destination device. In this example or any other example, the input device is an active stylus. In this example or any other example, the identifier corresponding to the screen-share destination device is received by decoding a change in electrical conditions detected at one or more display electrodes of the electronic display device, the change in electrical conditions caused by an electrostatic drive signal applied to one or more stylus electrodes of the active stylus. In this example or any other example, the identifier corresponding to the screen-share destination device is a media access control, MAC, address of the screen-share destination device.

In an example, an electronic display device comprises: a logic subsystem; and a storage subsystem holding instructions executable by the logic subsystem to: transit an identifier corresponding to the electronic display device to an input device separate from the electronic display device; receive a screen-share initialization request from the input device; initiate a screen-share pairing with a screen-share source device, the screen-share source device having received the identifier corresponding to the electronic display device from the input device; and on an electronic display of the electronic display device, display screen-share graphical content output by the screen-share source device. In this example or any other example, the instructions are further executable to transmit a security code to the input device, and initiate the screen-share pairing with the screen-share source device after authenticating the security code with the screen-share source device. In this example or any other example, the identifier corresponding to the electronic display device is transmitted to the input device via a radio-frequency, RF, communication modality. In this example or any other example, the identifier corresponding to the electronic display device is a media access control, MAC, address of the electronic display device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method at an input device for facilitating screen-share between a screen-share source device and a screen-share destination device, the method comprising the input device:
receiving, from the screen-share destination device, an identifier corresponding to the screen-share destination device;
detecting a screen-share initiating user input to initiate screen sharing between the screen-share destination device and the screen-share source device;
transmitting a screen-share initialization request to the screen-share destination device; and
transmitting the identifier of the screen-share destination device to the screen-share source device to facilitate establishment of a screen-share pairing between the screen-share source device and the screen-share destination device, wherein the screen-share pairing enables graphical content rendered by the screen-share source device to be displayed by the screen-share destination device.

2. The method of claim 1, wherein the identifier is received from the screen-share destination device via a first communication modality, and the identifier is transmitted to the screen-share source device via a second communication modality, different from the first communication modality.

3. The method of claim 2, wherein the first communication modality is a radio-frequency (RF) communication modality, and wherein the second communication modality is an electrostatic communication modality, in which one or more electrodes of the input device are driven with an encoded drive signal that influences electrical conditions at one or more electrodes of the screen-share source device.

4. The method of claim 1, further comprising receiving a security code from the screen-share destination device, and transmitting the security code to the screen-share source device.

5. The method of claim 1, wherein detecting the screen-share initiating user input includes detecting actuation of a physical button of the input device.

6. The method of claim 5, wherein a logic controller of the input device is configured to recognize two or more different predefined input types that are each associated with different actuation profiles of the physical button, the two or more different predefined input types including the screen-share initiating user input.

7. The method of claim 6, wherein an actuation profile associated with the screen-share initiating user input specifies one or both of an actuation duration of the physical button, and a number of separate actuations of the physical button within a threshold time interval.

8. The method of claim 1, wherein the identifier corresponding to the screen-share destination device is a media access control, MAC, address of the screen-share destination device.

9. The method of claim 1, wherein the input device is physically distinct from each of the screen-share source device and the screen-share destination device.

10. A computing device, comprising:
a logic subsystem; and
a storage subsystem holding instructions executable by the logic subsystem to:
render local graphical content for display via an electronic display device communicatively coupled with the computing device;
receive, from an input device separate from the computing device, an identifier corresponding to a screen-share destination device, the identifier originating from the screen-share destination device and relayed by the separate input device, the screen-share destination device different from the electronic display device;
initiate a screen-share pairing with the screen-share destination device based at least in part on the identifier; and
output screen-share graphical content for display by the screen-share destination device.

11. The computing device of claim 10, wherein the screen-share graphical content output for display by the screen-share destination device duplicates the local graphical content.

12. The computing device of claim 10, wherein the screen-share destination device is classified as an extended display of the computing device, and wherein the screen-share graphical content output for display by the screen-share destination device is different from the local graphical content.

13. The computing device of claim 10, further comprising receiving, from the input device, a security code originating from the screen-share destination device, and wherein initiating the screen-share pairing includes authenticating the security code with the screen-share destination device.

14. The computing device of claim 10, wherein the input device is an active stylus.

15. The computing device of claim 14, wherein the identifier corresponding to the screen-share destination device is received by decoding a change in electrical conditions detected at one or more display electrodes of the electronic display device, the change in electrical conditions caused by an electrostatic drive signal applied to one or more stylus electrodes of the active stylus.

16. The computing device claim 10, wherein the identifier corresponding to the screen-share destination device is a media access control, MAC, address of the screen-share destination device.

17. An electronic display device, comprising:
a logic subsystem; and
a storage subsystem holding instructions executable by the logic subsystem to:
transmit an identifier corresponding to the electronic display device to an input device separate from the electronic display device;
receive a screen-share initialization request from the input device;
initiate a screen-share pairing with a screen-share source device, the screen-share source device having received the identifier corresponding to the electronic display device from the input device; and
on an electronic display of the electronic display device, display screen-share graphical content output by the screen-share source device.

18. The electronic display device of claim 17, wherein the instructions are further executable to transmit a security code to the input device, and initiate the screen-share pairing with the screen-share source device after authenticating the security code with the screen-share source device.

19. The electronic display device of claim 17, wherein the identifier corresponding to the electronic display device is transmitted to the input device via a radio-frequency, RF, communication modality.

20. The electronic display device of claim 17, wherein the identifier corresponding to the electronic display device is a media access control, MAC, address of the electronic display device.
